(19) United States
(12) Patent Application Publication
(10) Pub. No.: US 2012/0256809 A1
(43) Pub. Date: Oct. 11, 2012

(54) APPARATUS FOR MOUNTING A CABLE CONNECTOR

(75) Inventor: David M. Lettkeman, Parker, CO (US)

(73) Assignee: DISH Network L.L.C., Englewood, CO (US)

(21) Appl. No.: 13/081,364

(22) Filed: Apr. 6, 2011

(51) Int. Cl. H01Q 1/12; F16L 3/22; F16M 13/02

(52) U.S. Cl. 343/890; 248/218.4; 248/219.4; 248/68.1; 248/224.8

(57) ABSTRACT

Described herein are mounting plates for securing cabling to another object. A mounting plate includes a body and at least one first through hole positioned along a surface of the body. The first through hole is configured to receive a cable connector. The mounting plate further includes at least one second through hole positioned along the surface of the body. The second through hole is configured to receive at least one securing mechanism, the securing mechanism configured to secure the mounting plate to another object.

### BACKGROUND

Small satellite dishes may be mounted to the outside of a structure, such as a home and allow a viewer to receive communication services, such as television programming, via a communication satellite. The satellite dish includes an antenna, such as a low noise blocking (LNB) converter, for receiving television programming from the communication satellite. The LNB may include multiple coaxial outputs which are connected to cabling that transmits communication signals into a structure for further processing by one or more satellite receivers, such as a television receiver set-top box. The cabling is usually connected to the LNB through a channel in the feedhorn arm of the satellite antenna installation. However, if problems later arise with the installation of the satellite antenna, it is often inconvenient for a technician to disconnect the coaxial cables in order to perform various testing procedures to isolate the problem. Thus, mounting solutions are desired that provide a more convenient connection point for coaxial cables to facilitate installation, testing and troubleshooting.

### BRIEF DESCRIPTION OF THE DRAWINGS

The same number represents the same element or same type of element in all drawings.

FIG. 1A illustrates an exploded view of an embodiment of a satellite antenna mounting environment.

FIG. 1B illustrates an assembled view of the embodiment of the satellite antenna mounting environment.

FIG. 2 illustrates an exploded top view of an embodiment of the mounting plate of FIG. 1.

FIG. 3 illustrates an assembled side view of the mounting plate installation of FIG. 1.

FIG. 4 illustrates an embodiment of a process for mounting cabling to a structure.

### DETAILED DESCRIPTION OF THE DRAWINGS

Described herein are apparatus, systems and methods for mounting objects, such as satellite antennas and associated cabling and components. More particularly, described herein are mounting plates which facilitate securing of cabling to an antenna or other object. The plate mounts to an object and is configured to secure one or more cable connectors. Thus, the mounting plate provides a convenient point of access to allow a technician to test cabling running into a structure as well as to test cabling and electronics associated with an antenna. Additionally. the mounting plate provides a level surface for connecting cable in order to avoid water migration.

At least one embodiment provided herein is a cabling mounting plate. The mounting plate includes a body and at least one first through hole positioned along a surface of the body. The first through hole is configured to receive a cable connector. The mounting plate further includes at least one second through hole positioned along the surface of the body. The second through hole is configured to receive at least one securing mechanism, the securing mechanism configured to secure the mounting plate to another object.

Another embodiment provided herein comprises a satellite antenna system including an antenna mast, an antenna mounted on the antenna mast, a first cable communicatively coupled to the antenna and a second cable. In at least one embodiment, the second cable is communicatively coupled to a receiving device, such as a satellite television receiver. The first and second cables are communicatively coupled by a cable connector. The system further includes a mounting plate including at least one first through hole configured to receive and secure the cable connector and at least one second through hole configured to receive a securing mechanism. The securing mechanism is configured to secure the plate to the mast. In at least one embodiment, the securing mechanism comprises a threaded member configured to secure the plate to the mast.

The techniques illustrated herein will be described in the context of mounting a satellite antenna to a structure. However, it is to be appreciated that the techniques described herein may be applied to mounting any type of antenna to any type of object, such as a pole, recreational vehicle, fence and the like. Furthermore, the techniques described herein may be applied to mounting of any type of electrical component to any type of object which utilizes a cable connector, such as mounting a security camera to the side of building.

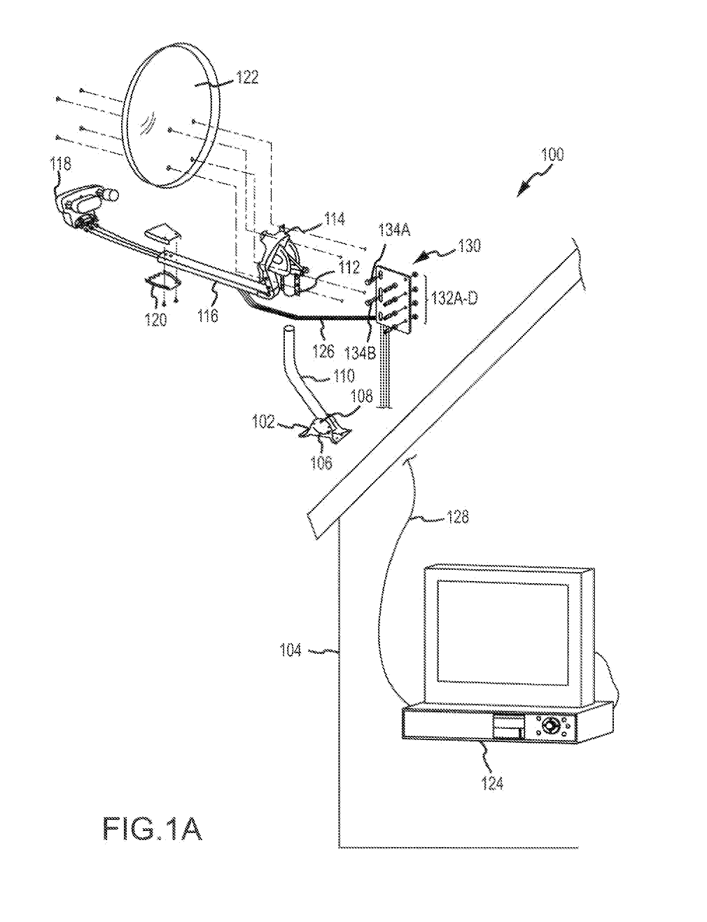

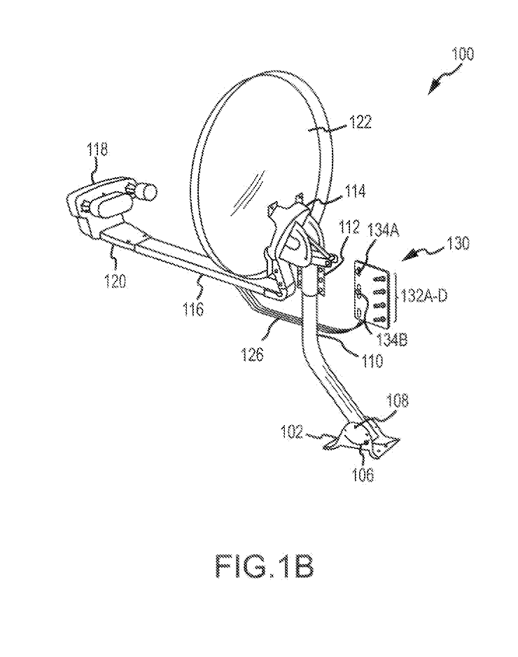

FIG. 1A illustrates an exploded view of an embodiment of a satellite antenna mounting environment 100. FIG. 1B illustrates an assembled view of the embodiment of the satellite antenna mounting environment 100. The environment 100 illustrates a satellite antenna mounted to a structure 104. The environment 100 of FIG. 1 includes a base 102, a structure 104, a mast adjustment bolt 106, a pivot bolt 108, a mast 110, a mast clamp 112, a reflector mounting bracket 114, a feedhorn arm 116, an antenna 118, an adapter bracket 120, a satellite reflector 122, a receiving device 124, first cabling 126, second cabling 128, a mounting plate 130, cable connectors 132A-132D and securing mechanisms 134A-134B. Each of these components will be discussed in greater detail below. The environment 100 may include other components not illustrated for the sake of brevity.

The base 102 is attached to a side of the structure 104. The base 102 is attached to the mast 110 via the pivot bolt 108 and the adjustment bolt 106. The mast 110 is attached to the feedhorn arm 116 via the mast clamp 112. The feedhorn arm 116 suspends the antenna 118 (also known as an LNB) away from the satellite reflector 122. First cabling 126 is coupled to the antenna 118 and communicatively couples to the cable connectors 132A-132D. In at least one embodiment, the cable connectors 132A-132D are threaded to receive like connectors of the first cabling 124 (and/or the second cabling 126). More particularly, the first cabling 126 is positioned to be secured within a channel of the feedhorn arm 116. The antenna 118 is secured to the feedhorn arm 116 via the adapter bracket 120.

The satellite reflector 122 is secured to the mast 110 via the reflector mounting bracket 114. As illustrated in FIGS. 1A and 1B, the mounting plate 130 is secured to the mast clamp 112 using one or more securing mechanisms 134A-134B. More particularly, the mounting plate 130 includes a plurality of through holes which receive the securing mechanisms 134A-134B. In at least one embodiment, the securing mechanisms 134A-134B comprise threaded members, such as screws, bolts and/or nuts.

The mounting plate 130 further includes a plurality of through holes which receive and secure the plurality of cable connectors 132A-132D. The first cabling 126 communicatively couples to a first end or the cable connectors 132A-132D. The second cabling 128 communicatively couples to a second opposing end of the cable connectors 132A-132D. The second cabling 128 is further communicatively coupled to one or more receiving devices 124 within the structure 104. For example, in at least one embodiment, the first and second cabling 126 and 128 includes four sets coaxial cables that communicatively couple the antenna 118 to multiple receiving devices 124 within the home. The mounting plate 130 provides an easy point of access to allow a technician to easily disconnect the antenna 118 from the receiving device 124 via the cable connectors 132A-132D and test the various connections to each device. Furthermore, the mounting plate 130 prevents water migration along the cabling 126 and 128.

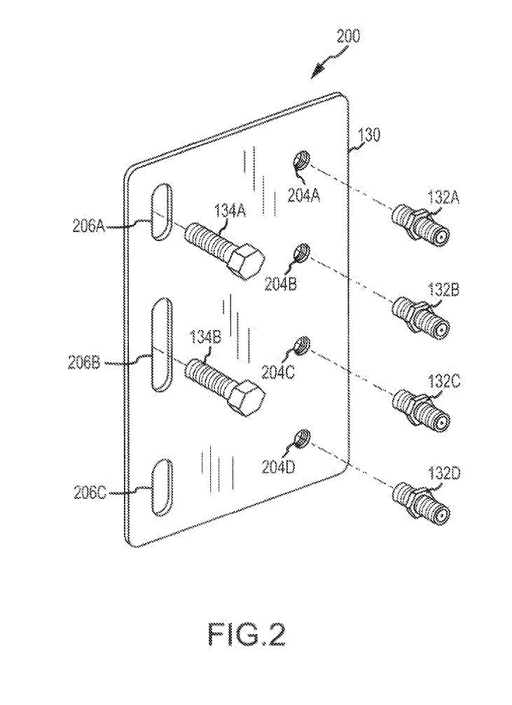

FIG. 2 illustrates an exploded top view 200 of an embodiment of the mounting plate 130 of FIG. 1. The mounting plate 130 includes a body 202, first through holes 204A-204D and second through holes 206A-206D. Each of these components will be discussed in greater detail below. The mounting plate 130 may include other components not illustrated for the sake of brevity.

In at least one embodiment, the body 202 comprises a planar surface made of appropriate material, such as metal or plastic. Though the body 202 is shown having a generally rectangular shape, it is to be appreciated that the body 202 may have any appropriate shape, such as a square, circle, triangle or the like depending on desired design criteria. The first through holes 204A-204D are positioned along a surface of the body 202 and are configured to receive the cable connectors 132A-132D. The first through holes 204A-204D may be sized and shaped according to a desired size of the cable connectors 132A-132D. For example, the cable connectors 132A-132D may comprise barrel connectors configured to communicatively couple F-connectors of two coaxial cables. Thus, the first through holes 204A-204D may be sized to fit an F-connection barrel connector. In at least one embodiment, the first through holes 204A-204D may be threaded to secure appropriately sized and like threaded cable connectors 132A-132D. In other embodiments, the planar surface make include appropriate raised sections surrounding the first and second through holes 204A-204D (also known as embosses) that allowing locking of the cable connectors 132A-132D in place within the first through holes 204A-204D. In at least one embodiment, the mounting plate 130A may include varying sized first through holes 204A-204D sized to fit various sized and shaped cable connectors. Furthermore, the mounting plate 130 may include any number of first through holes 204A-204D depending on desired design criteria.

The body 202 further includes a plurality of second through holes 206A-206C positioned along the surface of the body 202. Each of the second through holes 206A-206C are configured to receive at least one securing mechanism 134A-134B. The securing mechanisms 134A-134B secure the mounting plate 130 to the mast clamp 112. In at least one embodiment, the second through holes 206A-206C may be sized according to the size of the securing mechanisms 134A-134B. For example, the second through holes 206A-206C may be sized to fit standard sized bolts. In other embodiments, the second through holes 206A-206C may be sized larger than the size of the securing mechanisms 134A-134B in order to facilitate mounting of the plate 130 in various positions behind the mast clamp 112. In is to be appreciated that the mounting plate 130 may include any number of second through holes 206A-206C in any position along the surface of the body 202 depending on desired design criteria.

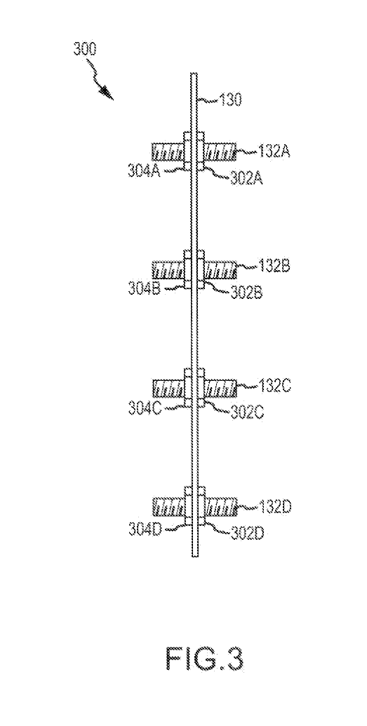

FIG. 3 illustrates an assembled side view 300 of the mounting plate 130 installation of FIG. 1. As illustrated in FIG. 3, the mounting plate 130 secures multiple cable connectors 132A-132D, which threadably attach to the first through holes 204A-204D (see FIG. 2). Each of the cable connectors 132A-132D includes a thicker center portion 302A-302D which is configured to secure the cable connector 132A-132D in place against a first side of the plate 130. A threaded member 304A-304D is configured to threadably attach to each of the barrel connectors on an opposing second side of the plate 130, securing the cable connectors 132A-132D to the plate 130. As further illustrated in FIG. 3, the plate 130 is secured to the mast clamp 112 via the securing mechanisms 134A-134B. The mounting plate 130 thus provides an easy access point allowing a technician to disconnect the antenna 118 from the receiving device 124 to provide trouble shooting within the environment 100.

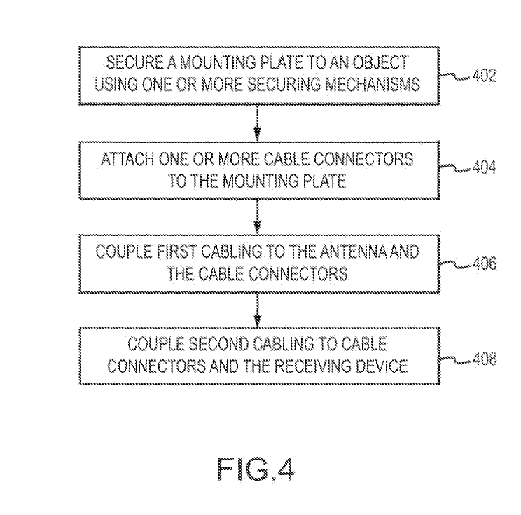

FIG. 4 illustrates an embodiment of a process for mounting cabling to a structure. More particularly, the process of FIG. 4 will be described in the context of mounting coaxial cabling to a satellite antenna. However, it is to be appreciated that the mounting process may be utilized to secure any type of cabling to any type of object. The process of FIG. 4 may include other operations not illustrated for the sake of brevity.

The process includes securing a mounting plate 130 to an object (such as the mast clamp 112) using one or more securing mechanisms 134A-134B (operation 402). The process further includes attaching one or more cable connectors 134A-134D to the mounting plate 130 (operation 404). The process further includes coupling first cabling 126 to the antenna 118 and the cable connectors 134A-134D (operation 406). The process further includes coupling second cabling 126 to cable connectors 134A-134D and the receiving device 124 (operation 408).

Although specific embodiments were described herein, the scope of the invention is not limited to those specific embodiments. The scope of the invention is defined by the following claims and any equivalents therein.

I claim:

1. A system comprising:
an antenna mast;
an antenna mounted on the antenna mast;
a first cable communicatively coupled to the antenna;
a second cable; and
a mounting plate including:
at least one first through hole configured to receive a cable connector; and
at least one second through hole configured to receive a securing mechanism, the securing mechanism configured to secure the plate to the mast;
the cable connector configured to couple the first and second cables.

2. The system of claim 1, wherein the first through hole is circular shaped.

3. The system of claim 2, wherein the first through hole is configured to receive a barrel connector.

4. The system of claim 3, wherein the first through hole threadably attaches to the barrel connector.

5. The system of claim 4, further comprising a threaded member configured to attach to a first end of the barrel connector, the threaded member configured to secure the barrel connector to the mounting plate.

6. The system of claim 3, wherein the mounting plate includes a plurality of the first through holes, each of the first through holes configured to receive a barrel connector.

7. The system of claim 1, wherein the mounting plate includes a plurality of the second through holes, each of the second through holes configured to receive a threaded securing mechanism that secures the mounting plate to the antenna mast.

8. A system comprising:
a mounting plate including;
a body;
a plurality of first through holes positioned along a surface of the body, each of the first through holes configured to receive a cable connector; and
a plurality of second through holes positioned along the surface of the body, each of the second through holes configured to receive at least one securing mechanism, each of the securing mechanisms configured to secure the mounting plate to an antenna mast.

9. The system of claim 8, wherein the antenna mast comprises a satellite antenna mast.

10. The system of claim 8, wherein each of the first through holes is configured to receive a barrel connector.

11. The system of claim 10, wherein the first through hole threadably attaches to the barrel connector, the system further comprising at least one threaded member configured to attach to a first end of one of the barrel connectors, the threaded member configured to secure the barrel connector to the mounting plate.

12. The system of claim 10, further comprising:
a first cable communicatively coupled to at least one barrel connector and an antenna; and
a second cable communicatively coupled to the at least one barrel connector and a receiving device.

13. The system of claim 12, wherein the receiving device comprises a television receiver.

14. A system comprising:
a mounting plate including;
a body;
at least one first through hole positioned along a surface of the body, the first through hole configured to receive a cable connector; and
at least one second through hole positioned along the surface of the body, the second through hole configured to receive at least one securing mechanism, the securing mechanism configured to secure the mounting plate to another object.

15. The system of claim 14, wherein the securing mechanism is configured to secure the mounting plate to an antenna mast.

16. The system of claim 15, wherein the antenna mast comprises a satellite antenna mast.

17. The system of claim 14, wherein the first through hole is circular shaped.

18. The system of claim 17, wherein the first through hole is configured to receive a barrel connector.

19. The system of claim 14, wherein the mounting plate includes a plurality of the first through holes, each through hole configured to receive a cable connector.

20. The system of claim 14, wherein the first through hole threadably attaches to the barrel connector, the system further comprising at least one threaded member configured to attach to a portion of one of the barrel connectors, the threaded member configured to secure the barrel connector to the mounting plate.
